(19) United States
(12) Patent Application Publication
(10) Pub. No.: US 2003/0031585 A1
(43) Pub. Date: Feb. 13, 2003

(54) Particulate catalysts

(76) Inventor: Gianluca Li Puma, Toton (GB)

Correspondence Address: FULBRIGHT & JAWORSKI L.L.P., SUITE 2400, 600 CONGRESS AVENUE, AUSTIN, TX, 78701-3271, US

(21) Appl. No.: 10/157,002

(22) Filed: May 29, 2002

Related U.S. Application Data
(60) Provisional application No. 60/295,388, filed on Jun. 1, 2001.

(51) Int. Cl. C02F 1/30; B01J 31/00; B01J 31/06; B01J 31/08

(52) U.S. Cl. 422/23; 502/159; 210/748

(57) ABSTRACT

The invention discloses particulate catalysts and, more specifically, particulate catalysts for use in heterogeneous photo-assisted Fenton reactions. Immobilisation of metal ions on a compatible particulate support provides an improved catalysts that avoids both the pH-dependency and the need for catalyst recovery. In particular, ferrous or ferric ions are employed.

This invention relates to particulate catalysts and especially to particulate catalysts,for use in heterogeneous photo-assisted Fenton reactions.

### BACKGROUND TO THE INVENTION

(A) Fenton Reaction and Photo-Assisted Fenton Reaction

Advanced Oxidation Technologies (AOT) are powerful techniques for the destruction of recalcitrant organics and have been commercially exploited for use in water and wastewater treatment. The Fenton reaction (1) is an AOT based on the production of hydroxyl radicals (·OH) which act as strong oxidising agents, capable of degrading organic pollutants almost instantaneously (Reaction 2).

Fe²⁺+H₂O₂→Fe³⁺+OH⁻⁺·OH (1)

OH+organics→(several steps..)→CO₂+H₂O+mineral acids+salts (2)

One of the drawbacks of the Fenton reaction is that the overall oxidation rate is considerably slowed down after conversion of Fe²⁺ to Fe³⁺, as the reduction of Fe³⁺ to Fe²⁺ (Reaction 3) is much slower than Reaction (1).

Fe³⁺+H₂O₂⇄Fe(OOH)²⁺H⁺→Fe²⁺+HO₂·+H⁺ (3)

The application of UV-visible irradiation to the Fenton reaction system, the Photo-Assisted Fenton Reaction, regenerates Fe²⁺ by photolysis of hydroxide complexes of Fe³⁺, yielding more hydroxyl radicals (Reaction 4).

Fe(OH)²⁺+hv→Fe²⁺+·OH (4)

The Fe²⁺ ion now acts as a catalyst and the degradation rates of many organic compounds (e.g. herbicides, polychlorinated biphenyls, chlorophenols) are greatly enhanced (Reaction 2).

The Fenton and the Photo-assisted Fenton reactions both require operation at pH <4, to avoid the precipitation of the ferrous oxide from the solution.

(B) Heterogeneous Photo-Fenton Reaction

Although the Fenton and the photo-assisted Fenton reactions are used commercially, they have not been widely exploited because of the high expense of pH adjustment (pH <4 to avoid precipitation of the ferrous oxide) and of catalyst recovery. For example, the treatment of wastewater at pH 7, by photo-assisted Fenton oxidation followed by biological oxidation, requires an initial adjustment to pH <4 prior to photo-assisted Fenton oxidation, followed by another pH adjustment to pH 7 prior to biological treatment.

In addition, environmental agencies in many industrialised countries generally require wastewater discharge to be at pH not less than 6.

The applicant has found that immobilisation of metal ions on a compatible particulate support provides a catalyst for heterogeneous photo-assisted Fenton reactions, the use of which avoids both the pH-dependency of said reactions and the need for catalyst recovery.

Accordingly, the present invention provides, in a first aspect, a catalyst for heterogeneous photo-assisted Fenton reactions, said catalyst comprising metal ions immobilised and supported on a compatible particulate material.

The metal ions may consist of ferrous (Fe²⁺) and/or ferric (Fe³⁺) ions.

The particulate material (such as beads or granules) may wholly or partially comprise an ion-exchanger material. Alternatively the beads or granules may be impregnated or coated with an ion-exchanger material. Preferably the impregnating or coating material consists essentially of an ion exchanger. The beads or granules may suitably have an average particle size of from 10⁻⁹ to 10⁻¹ metres.

Preferably, the ion-exchanger material has a carbon-fluorine backbone chain and perfluorinated side chains, said side chains further containing sulphonic acid groups.

An example of such a particulate material is available from Du Pont (UK) Limited as NAFION® NR 50.

In a second aspect, the present invention provides a method for the treatment of fluids, such as water and wastewater containing organic or inorganic materials and/or micro-organisms, said method consisting essentially of carrying out a photo-assisted Fenton reaction upon said fluid, wherein said photo-assisted Fenton reaction is catalysed by means of a catalyst according to the first aspect of the present invention (as hereinabove described).

Ion-exchange resins, especially NAFION®-based resins, have been found to act as an effective support for the metal ions. They have also been found to meet the main criteria for the photo-assisted Fenton reaction, namely resistance to extreme oxidative conditions, stability and relative transparency to UV/visible radiation.

The applicant has further found that the catalysts of the present invention have the following advantages when used in a photo-assisted Fenton reaction:

1) The use of a particulate catalyst allows the catalyst to be loaded on to a variety of photoreactor configurations, including for example fixed-bed, rotating or mobile catalyst basket and slurry-type (fluidised-bed or mechanically-stirred).

2) By using a particulate catalyst, a high surface area is exposed to both photons and substrates and a high overall reaction efficiency is obtained.

3) The utilisation of a particulate support has the advantage of catalysing both the photo-assisted and the dark Fenton reactions, the latter occurring in the space of the particle where light intensity is limited by the geometry of the particle (as the particle may be porous). The two reactions proceeding simultaneously may have a synergistic effect.

4) Reduction of reaction times due to improved capacity for mixing.

For example, in slurry type reactors the catalyst exposed to irradiation is continuously renewed by mixing and a higher overall reaction efficiency is obtained.

5) Continuous flow reaction operation allows high processing rates.

6) The metal ions remain anchored to the particulate support, over a wide range of pH values. Operation in the neutral pH range (pH ˜6-8) makes the system compatible with biological systems and greatly increases the applicability of the photo-assisted Fenton reaction.

7) No metal ion recovery system is needed.

Applications of the catalysts of the present invention include (though are not limited to) the following:

Fluid purification: potable water purification (industrial scale), potable water purification (house-hold scale), fluid disinfection, production of ultra-pure water (e.g. for laboratory research, for medical applications and for microelectronics and pharmaceutical industries).

Treatment of fluid waste: groundwater remediation, industrial wastewater treatment, destruction of organic and inorganic pollutants, colour removal, odour removal, pathogen deactivation, remediation of landfill leachate, and municipal wastewater treatment (primary treatment or tertiary treatment).

The catalysts of the present invention are anticipated to be active in the degradation of many organic contaminants, including pesticides, herbicides, pharmaceuticals, halogenated hydrocarbon, phenols, polychlorinated biphenyls, heteroatoms, nitro-organics and many others.

A light source consisting essentially of artificial light or solar radiation is used to initiate said photo-assisted Fenton reaction.

The present invention will be illustrated by way of the following non-limiting Example.

### Example

### Degradation of an Aqueous Solution of Indigo Carmine

A portion of NAFION® NR50 beads, 7-9 mesh, was exchanged for 30 minutes with a solution of ferric chloride in ultrapure water. After washing three times with ultrapure water, the catalyst was yellow in colour, indicating the exchange with Fe³⁺. The catalyst was washed and then immersed in a sodium hydroxide solution to convert Fe³⁺ to its hydrated form. The colour of the catalyst changed to a deep rusty red.

The catalyst was loaded on to an annular type photoreactor fitted with a 6-watt backlight lamp located at the centre of the annulus. The radiation emitted by this lamp alone is not sufficient to photo-split hydrogen peroxide to yield hydroxyl radicals.

The dimensions of the annulus were:

| | |
|---|---|
| inner wall diameter | 2.5 cm |
| outer wall diameter | 3.81 cm |

The depth of the catalyst bed was 150 mm and the volume of the photoreactor occupied by catalyst was 97.4 cm³.

Two loading configurations were used: 1) fixed packed bed and 2) in suspension (fluidised by the incoming fluid). In this example, a fixed packed bed configuration was used.

The photoreactor was fed with a synthetic aqueous solution of indigo carmine dye. The photoreactor was operated in a continuous-flow, single-pass mode through the catalyst bed. The reduction in concentration of the indigo carmine dye was monitored by HPLC and UV-spectroscopy.

The degree of conversion of the indigo carmine dye is dependent on the loading of catalyst. In this example, the conversions were carried out in a differential (very small) reactor. In larger reactors, the degree of conversion will be significantly greater.

Experiment 1

The effect of concentration of hydrogen peroxide on the degradation of indigo carmine dye was observed at pH 7.2, under two experimental conditions, lights on and lights off. The amount of indigo carmine dye in the feed was 40 ppm and the flow-rate was 0.155 L/min.

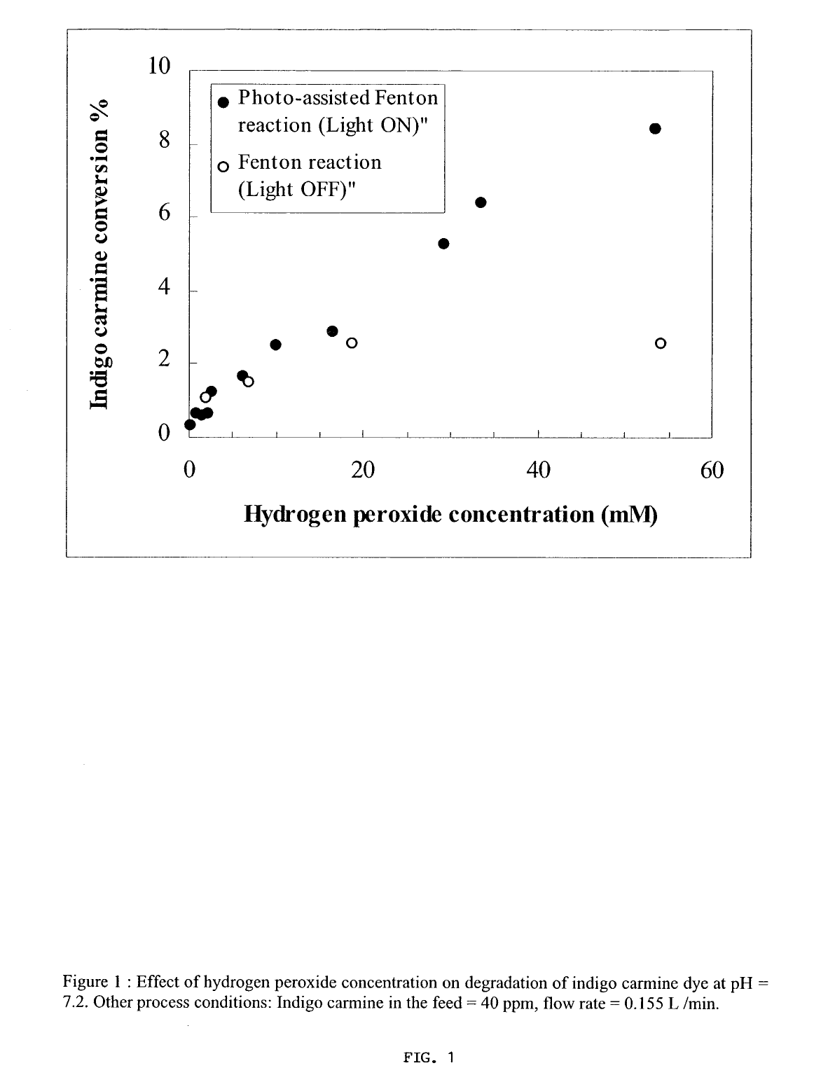

FIG. 1 of the accompanying drawings shows the effect of concentration of hydrogen peroxide on dye conversion. With lights on, degradation of the dye is due to a photo-assisted Fenton reaction. With lights off, only the Fenton reaction is occurring.

Experiment 2

Experiment 1 was repeated, but at pH 2.8.

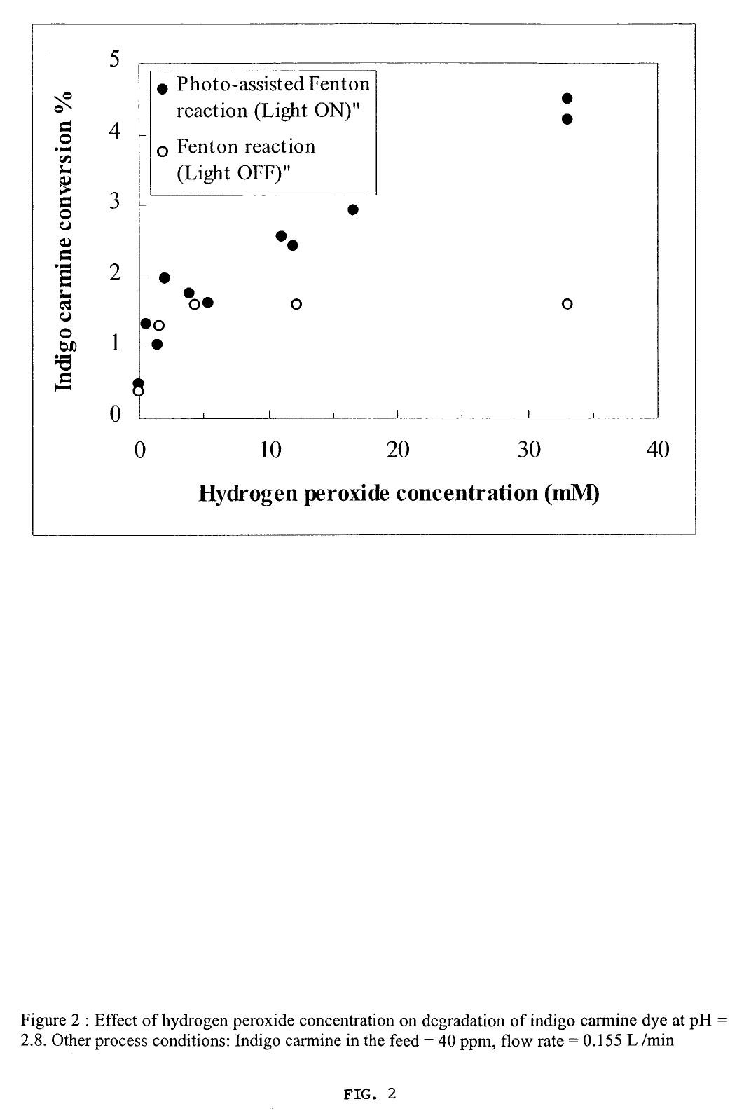

FIG. 2 of the accompanying drawings again shows the effect of concentration of hydrogen peroxide on dye conversion. The conversion with the photo-assisted Fenton reaction was found to be up to four times greater than the conversion with the Fenton reaction alone.

The results shown in FIGS. 1 and 2 indicate that the conversion of indigo carmine dye increases almost linearly with hydrogen peroxide concentration when the light is on, but reaches a plateau when the light is off.

Comparing the results in FIGS. 1 and 2, it can be seen that the conversion obtained at pH=7.2, with light on, is somewhat higher than that at pH=2.8. This is a new phenomenon, hitherto unseen in both homogeneous and heterogeneous photo-Fenton systems. Firstly, experiments at pH=7.2 would have not been possible with a homogeneous pboto-Fenton reaction system, because the iron catalyst would have precipitated out from the solution. Secondly, the rate of reaction observed with both homogeneous and heterogeneous photo-Fenton reaction systems has previously been reported to increase as the pH of the fluid is decreased, with maximum activity at pH=2.8. FIG. 1 shows that at pH=7.2 the present catalyst has higher activity than at pH 2.8.

The performance of the catalyst prepared as outlined above has been further characterised according to such parameters as effect of light intensity, substrate concentration, flow rate and pH of solution. The performance of the catalyst in degradation of other organic substances e.g. salicylic acid, has also been investigated.

1. A catalyst for heterogeneous photo-assisted Fenton reactions, said catalyst comprising metal ions immobilised and supported on a compatible particulate material.

2. The catalyst of claim 1, wherein said metal ions are selected from the group consisting of ferrous (Fe²⁺) ions and ferric (Fe³⁺) ions.

3. The catalyst of claim 1, wherein said particulate material consists essentially of beads or granules of an ion-exchanger.

4. The catalyst of claim 3, wherein said beads or granules have an average particle size of from 10⁻⁹ to 10⁻¹ metres.

5. The catalyst of claim 3, wherein said particulate material consists essentially of an ion-exchanger having a carbon-fluorine backbone chain and perfluorinated side chains, said side chains further containing sulphonic acid groups.

6. The catalyst of claim 1, wherein said particulate material consists essentially of beads or granules of a material impregnated and/or coated with an ion exchanger.

7. The catalyst of claim 6, wherein said beads or granules have an average particle size of from 10⁻⁹ to 10⁻¹ metres.

8. The catalyst of claim 6, wherein said impregnating and/or coating material consists essentially of an ion-exchanger having a carbon-fluorine backbone chain and perfluorinated side chains, said side chains further containing sulphonic acid groups.

9. A method for the treatment and purification of fluids containing organic or inorganic material or pathogens said method comprising carrying out a photo-assisted Fenton reaction upon said fluid or wastewater, wherein said photo-assisted Fenton reaction is catalysed by a catalyst according to claim 1.

10. A method according to claim 9, wherein said photo-assisted Fenton reaction is initiated by means of a light source.

11. A method according to claim 10, wherein said light-source consists essentially of artificial light.

12. A method according to claim 10, wherein said light-source consists essentially of solar radiation.

13. A method according to claim 9, wherein said catalyst consists essentially of metal ions selected from the group consisting of ferrous (Fe²⁺) ions and ferric (Fe³⁺) ions, said metal ions being immobilised and supported on beads or granules of an ion-exchanger, said ion-exchanger having a carbon-fluorine backbone chain and perfluorinated side chains said side chains further containing sulphonic acid groups.

14. A method according to claim 9, wherein said catalyst consists essentially of metal ions selected from the group consisting of ferrous (Fe²⁺) ions and ferric (Fe³⁺) ions, said metal ions being immobilised and supported on beads or granules of a compatible material, said material being impregnated or coated with an ion-exchanger having a carbon-fluorine backbone chain and perfluorinated side chains, said side chains further containing sulphonic acid groups.
